(19) United States
(12) Patent Application Publication
(10) Pub. No.: US 2005/0020716 A1
(43) Pub. Date: Jan. 27, 2005

(54) Combining method

(76) Inventors: Norifumi Hasegawa, Tokyo (JP); Nana Hayakawa, Tokyo (JP)

Correspondence Address: LORUSSO, LOUD&KELLY, 3137 Mount Vernon Avenue, Alexandria, VA, 22305, US

(21) Appl. No.: 10/891,034

(22) Filed: Jul. 15, 2004

(30) Foreign Application Priority Data
Jul. 22, 2003 (JP) 2003-277919

(51) Int. Cl. C08G 2/00; C08F 2/46; C08J 3/28

(52) U.S. Cl. 522/134; 522/146

(57) ABSTRACT

In a first process step, intermediate product dehydration polymerization of a hydrocarbon-based polymer including a metal alkoxide and phosphoric acid is performed to obtain an intermediate product. Then, in a second process step, the intermediate product is irradiated by microwaves with a wavelength that selectively imparts energy to a hydroxyl group included in the intermediate product. As a result, an electrolyte membrane is obtained that is composed from a skeleton formed from a hydrocarbon-based polymer and phosphoric acid that is proton conductive.

The disclosure of Japanese Patent Application No. 2003-277919 filed on Jul. 22, 2003 including the specification, drawings and abstract is incorporated herein by reference in its entirety.

### BACKGROUND OF THE INVENTION

1. Field of the Invention

The present invention relates to a combining method for combining a proton conducting material with a skeleton.

2. Description of the Related Art

As general-use electrolyte membranes, fluorine-based membranes are known that have a basic skeleton of perfluoroalkylene group, with an ion exchange group like sulfone group or carbon group attached to the terminal of a perfluoro-vinylether side chain in one portion (for example, the Nafion R membrane of Du Pont (see U.S. Pat. No. 4,330,654)). However, when such fluorine membranes are utilized in an electrolyte membrane of a fuel cell or a sensor, the operation temperature is limited to 100° C. or less due to the heal resisting properties of the electrolyte membrane. In addition, it is necessary to make sure that sufficient humidity is present to maintain ion resistance at a low level. Accordingly, there is demand in the fuel cell field for improvement in electricity generation efficiency and effective utilization of heat reduction technologies and techniques, and the like. Moreover, in the sensor field, there are calls for an increase in the range of ambient temperatures in which sensors can be installed. Thus, an electrolyte membrane that can operate in a high temperature/low humidity atmosphere is desired.

In this regard, Japanese Patent Laid-Open Publication No. 2000-272932 discloses a P₂O₅—MOx (M═Si, Ti, Zr, Al) based glass electrolyte which can operate at high temperatures of 100° C. or more. An electrolyte membrane formed from this glass electrolyte is obtained by drying a glass electrolyte that is formed synthetically using a sol-gel process. However, this electrolyte membrane is liable to crack, or the like, when humidity changes rapidly, and thus concerns have been raised about its durability when used in fuel cells, and so on. In order to avoid such problems, a spark plasma sintering (SPS) method has been proposed that enables glass electrolyte that is formed synthetically using the sol-gel process to be sintered so as to form an electrolyte membrane (refer to Japanese Patent Laid-Open Publication No. 2003-75040). However, the obtained electrolyte membrane has spaces present within it, which leads to difficulties related to permeation of gas through the spaces. Accordingly, utilization of this electrolyte membrane in fuel cells in which a gas barrier must be maintained between an anode (an air electrode) and a cathode (a fuel electrode) is problematic.

Given the above described circumstances, various electrolyte membranes have been proposed (as disclosed in Japanese Patent Laid-Open Publication Nos. 2001-35509, 2001-307545, 2002-15742, 2002-198067, and 2002-309016). These electrolyte membranes are hybrid combinations of (i) a skeleton configured from a hydrocarbon-based polymer, and (ii) a proton conducting material which is configured from an inorganic solid acid and which conducts protons. These electrolyte membranes have both gas barrier properties and heat resisting properties, and can be operated in a low humidity atmosphere.

However, sometimes, phosphoric acid is used in the proton conducting material of the above disclosed conventional hybrid electrolyte membranes. In this case, when the electrolyte membranes are used for a long period in conditions in which water is present, the phosphoric acid is eluted into the water, whereby proton conductivity is impaired.

### SUMMARY OF THE INVENTION

The present invention has been conceived of in the light of the above described problems, and aims to offer a solution by providing a combining method that enables an electrolyte membrane, an electrode, or the like, to maintain proton conductivity, even when used for a long period in conditions in which water is present.

The inventors have conducted high-level research concerning the cause of the above described deterioration in the proton conductivity of conventional hybrid electrolyte membranes. Further, they have discovered that the cause is related to elution of phosphorous that acts as the proton conducting material into the water from the skeleton. The inventors have found that it is possible to offer a solution by applying microwaves with a specific wavelength to the conventional hybrid electrolyte membrane so as to bond the skeleton and the proton conducting material (in particular, phosphorous or a phoshide). As a result of this research, the inventors have succeeded in realizing and perfecting the present invention.

More particularly, a combining method according to the present invention includes a step of combining a proton conducting material including a hydroxyl group with a skeleton formed from a hydrocarbon-based polymer. This combining step is achieved by performing irradiation with microwaves with a specific wavelength that selectively imparts energy to the hydroxyl group.

Accordingly, the combining method of the present invention enables an electrolyte membrane, an electrode, or the like, to be manufactured that can maintain proton conductivity even when used for a long period in conditions in which water is present.

The hydrocarbon-based polymer is used for the skeleton in order to (a) give the electrolyte membrane suitable flexibility, and (b) make handling and electrode formation easier. As the hydrocarbon-based polymer it is possible to utilize a polyether like poly-tetramethylene oxide, or a poly-methylene group.

For the proton conducting material, it is desirable to use phosphoric acid or a phoshide Moreover, phosphoric acid or phosphate are particularly suitable.

In the case that an intermediate product is manufactured from a skeleton formed from a hydrocarbon-based polymer, and a proton conducting material including a hydroxyl group, an example of the method used for obtaining the intermediate product is as follows. A substituent (like hydrolyzable silyl group or metal alkoxide that is capable of bonding with the proton conducting material) is introduced in advance to the hydrocarbon-based polymer. This substituent is used to covalently bond the skeleton and the proton conducting material. For example, it is possible to obtain a proton conducting material from phosphoric acid or phosphorus alkoxide using a sol-gel process. In this case, a hydrocarbon-based polymer with introduced alkoxide-silane is used as the skeleton, and phosphoric acid or phosphorous alkoxide is added to a solution thereof. Then, hydrolysis and intermediate product dehydration polymerization are performed, whereby it is possible to obtain an intermediate product in which the skeleton and the proton conducting material are covalently bonded.

The intermediate product obtained in this manner includes an unreacted portion where the intermediate product dehydration polymerization reaction has not taken place. Accordingly, if this intermediate product is used in this form for a long time in conditions in which water is present, the phosphorous elutes from the skeleton. As a result, proton conductivity is liable to reduce. Thus, according to the combining method of the present invention, in the process step that follows forming of the intermediate product, microwaves with a specific wavelength are applied. The wavelength of these microwaves selectively imparts energy to the hydroxyl group which is bonded with the phosphorous-oxygen bonds and which is included in the intermediate product. Accordingly, intermediate product dehydration polymerization takes place in the unreacted portion, and bonding of the phosphorous that is the proton conducting material and the skeleton takes places. As a result, it is possible to obtain an intermediate product which is not affected by phosphorous elution and which maintains proton conductivity even if used for a long time in conditions in which water is present.

By applying microwaves to the hydroxyl group included in the intermediate product, it is possible to polymerize the skeleton and the proton conducting material. In other words, bonding is facilitated since the microwaves apply energy to the hydroxyl group included in the intermediate product. Accordingly, microwaves are applied at one of the frequencies (namely, 915 MHz, 2,450 MHz, or several 10s of GHz) that are the H—O—H absorption bands associated with the intermediate product dehydration polymerization. As a result, it is possible to complete the reaction of the crosslinked structure. However, when a frequency of several 10s of GHz is used, efficiency is raised too much, and just the surface of the intermediate product is heated rapidly, whereby damage of the electrolyte membrane occurs. Accordingly, it is preferable if the microwaves are applied within a 900 MHz to 10 GHz band. By doing so, microwave irradiation can be used to locally irradiate energy at room temperature. This makes it possible to only promote the polymerization reaction of the proton conducting material, without causing damage to the hydrocarbon-based polymer that forms the skeleton.

The electrolyte membrane obtained as a result of the above process is able to maintain proton conductivity even if used for a long period in conditions in which water is present, since it is difficult for phosphorous to elute from the skeleton. Moreover, this electrolyte membrane simultaneously demonstrate (a) gas barrier properties and flexibility due to the hydrocarbon-based polymer, and also (b) proton conductivity in the low humidity range due to the proton conducting material. In addition, the hybrid combination of the crosslinked structure and the hydrocarbon-based polymer that forms the skeleton enables the electrolyte membrane to operate in a higher temperature range than conventional electrolyte membranes.

Moreover, the inventors have confirmed that the effects of the invention can also be obtained with an intermediate product that uses 3-isocyanate propyl-triethoxysilane and polyethylene oxide.

### BRIEF DESCRIPTION OF THE DRAWINGS

FIG. 1 is a graph showing proton conductivity of intermediate products according to ar embodiment;

FIG. 2 is a graph showing respective retention rates of phosphorous of electrolyte membranes according to first and second examples of the embodiment, and a comparative example;

FIG. 3 is a comparison graph showing respective proton conductivities of the second example according to the embodiment and the comparative example; and

FIG. 4 is a thermogravimetry-differential thermal analysis (TG-DTA) graph showing heat resisting properties of the intermediate product according to the embodiment.

### DETAILED DESCRIPTION OF THE PREFERRED EMBODIMENTS

Hereinafter, a specific embodiment of the present invention will be described with reference to the drawings.

First Process Step

Polyethylene glycol (average molecular weight, 200 to 1000) was adopted for the hydrocarbon-based polymer. As shown in Formula 1, the polyethylene glycol and 3-isocyanate propyl-triethoxysilane were reacted at 60 degrees C. in a tetrahydrofuran (THF) solvent for forty-eight hours under a nitrogen atmosphere. Ethoxysilane group was then introduced by urethane bonding. Then, as indicated by Formula 2, a skeleton was obtained by introducing substituent.

Formula 1
H(OC₂H₄)ₙOH+2(C₂H₅O)₃Si(CH₂)₃NCO
Formula 2
(C₂H₅O)₃Si(CH₂)₃NHOC(OC₂H₄)ₙOCONH(CH₂)₃Si(C₂H₅O)₃

Next, the skeleton with the attached substituent was dissolved in ethanol, and water and phosphoric acid were added. The obtained solution was poured into a PTFE made petri dish. Then, hydrolysis and intermediate product dehydration polymerization of the solution were performed at a temperature of 40 degrees C. in a hermetically sealed environment so as to obtain a gel. This gel was first dried for twenty-four hours at 40 degrees C., and then dried for twenty-four hours at 100 degrees C. (with a temperature increase rate of 10 degrees/minute). As a result, an intermediate product with thickness of around 0.3 mm was obtained. The added amount of phosphorous (P) with respect to silicon (Si) was 0.5 to 5 (molar ratio). In this way, it was possible to obtain the intermediate product without any dependency on the average molecular weight of the polyethylene glycol.

Second Process Step

The intermediate product obtained by the first process step was irradiated with microwaves of 500 Watts at a frequency of 2,450 MHz so as to insolubilize the phosphorous.

Evaluation of Proton Conductivity

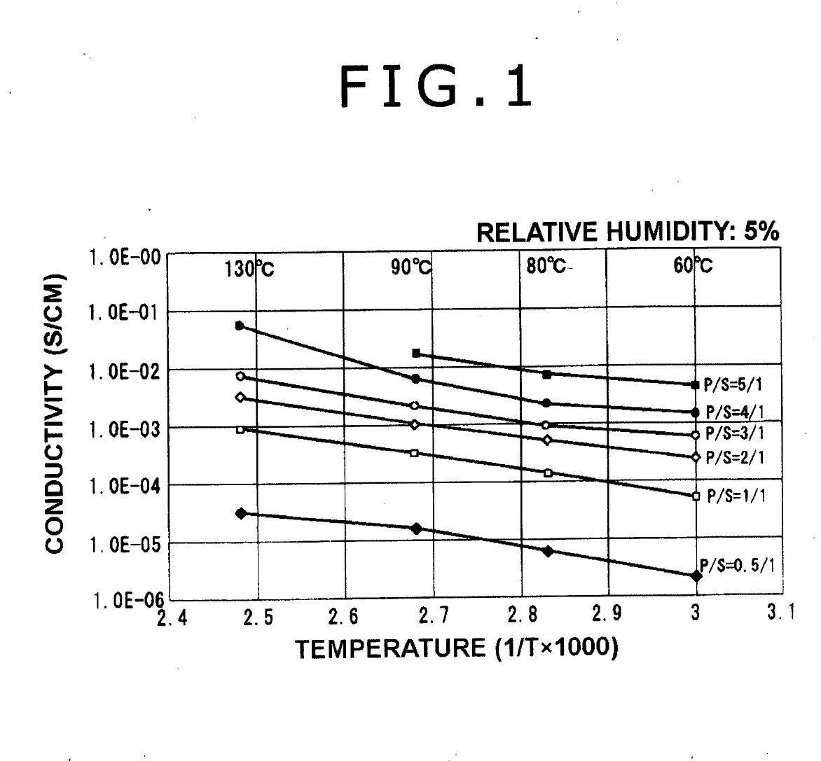

Intermediate products with various phosphorous concentrations (in a range from P/Si 0.5/1 to 5/1) were obtained using the first process step described above. The respective intermediate products, which were formed to have a thickness of around 0.5 mm, were cut into squares of around 1.5 cm in a petri dish. Then, a sputter method was used to deposit gold electrodes on both sides of the cut intermediate product, and a lead line was attached to each electrode. The respective intermediate products were then placed into a variable temperature-humidity chamber under a nitrogen atmosphere, and impedance was measured using an LCR meter. In this way, the ion conductivity (S/cm) of each intermediate product was measured. Note that, the average molecular weight of the polyethylene glycol was 400. The measurement results that were obtained at a relative humidity of 5% are shown in FIG. 1.

As is apparent from FIG. 1, all of the intermediate products simultaneously demonstrate (i) gas barrier properties and flexibility due to the polyethylene glycol, and also (ii) proton conductivity in the low humidity range due to the phosphoric acid. Moreover, it is also clear that all of the intermediate products have an increased phosphorous content and improved proton conductivity.

Elution Test

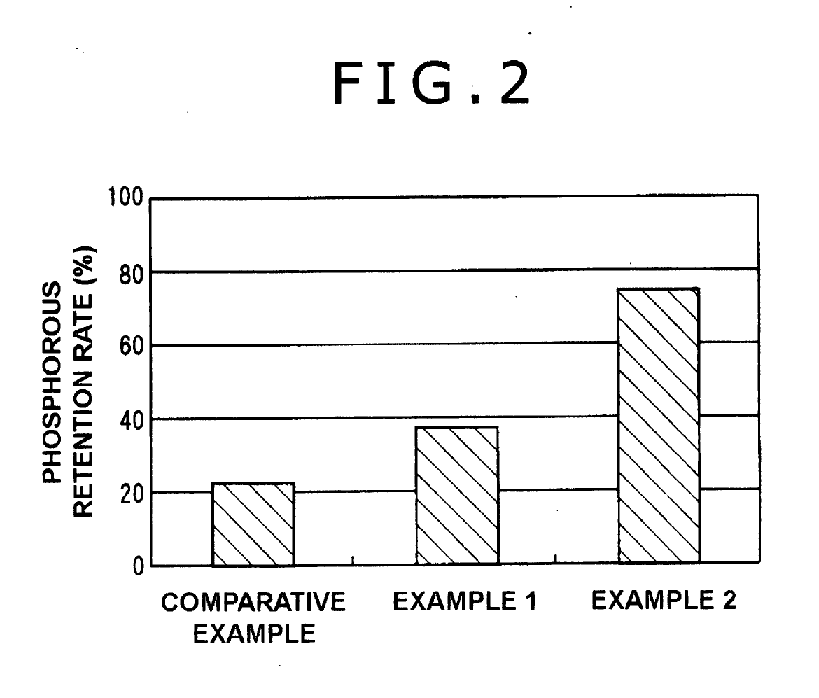

First and second examples (described below) and a comparative example of the electrolyte membrane were immersed in pure water, and left for twenty-four hours at room temperature The examples were then removed and dried, and their phosphorous concentration was measured by performing elemental analysis using an X-ray microanalyser. The phosphorous retention rate (%) was then calculated by taking the respective pre-immersion phosphorous contents of the first, second and comparative examples of the electrolyte membrane as reference values. The results of this analysis are shown in FIG. 2.

Among the intermediate products obtained from the first process step, the product with an average molecular weight of polyethylene glycol of 400 and a phosphorous to sulfur ratio of 2:1 was irradiated with microwaves at a frequency of 2,450 MHz for one minute. At this time, the microwave output was set at 250 or 500 Watts. The electrolyte membrane obtained with the 250 Watt microwave output was used as the first example, and that obtained with the 500 Watt microwave output was used as the second example. Note that, the comparative example is a electrolyte membrane (intermediate product) that was not subject to irradiation by microwaves.

As can be seen from FIG. 2, the comparative example electrolyte membrane that was not irradiated by microwaves has a phosphorous retention rate of around 20%. However the first example electrolyte membrane irradiated with 250 Watt microwaves shows a phosphorous retention rate of around 40%, and that of the second example electrolyte membrane irradiated with 500 Watt microwaves is near to 80%. In light of the above proton conductivity evaluation it is apparent that proton conductivity is higher when phosphorous content is high. Accordingly, as compared to the electrolyte membrane of the comparative example, the electrolyte membranes of the first and second examples exhibit superior proton conductivity when used for a long period in conditions in which water is present.

It should be noted that it is also preferable if irradiation is performed with a microwave output of 500 Watts rather than 250 Watts. However, if the output level is too large, and irradiation is performed for a long time, there is a possibility that the electrolyte membrane will be damaged due to surface temperature increase. Accordingly, an optimal balance of microwave output and irradiation time is set. Of course, it is desirable if the optimal combination of these parameters is set based on a weight of the intermediate product, a surface area thereof and a thickness thereof.

Measurement of Proton Conductivity

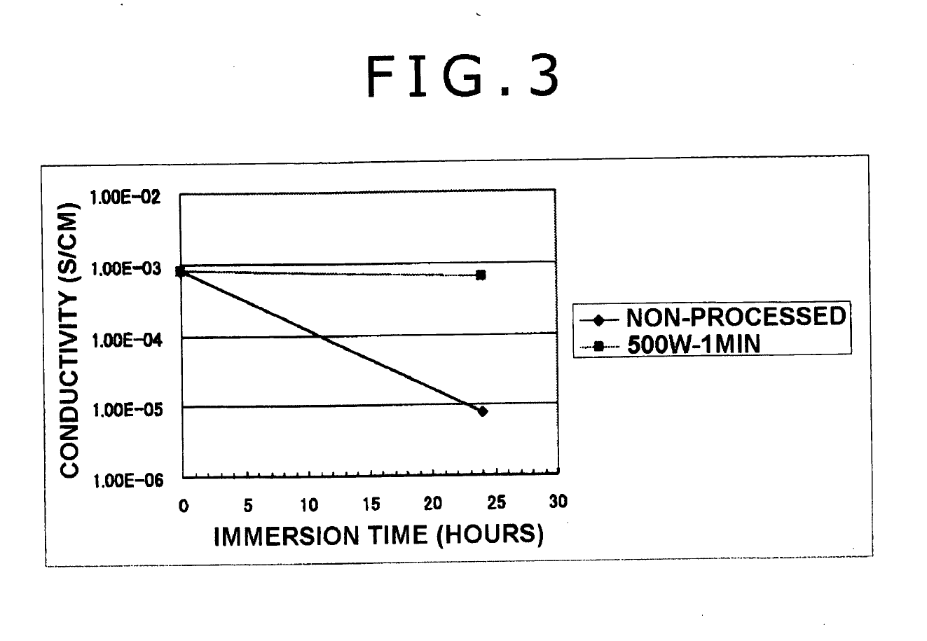

The second example electrolyte membrane and the comparative example electrolyte membrane (respective intermediate products) were immersed in pure water, and left for twenty-four hours at room temperature. Following this, the electrolyte membranes were dried, and ion conductivity (S/cm) was measured in the same manner as described previously. The results are shown in FIG. 3.

The electrolyte membrane of the second example that was irradiated by microwaves has a high phosphorous retention rate as discussed previously. Thus, as shown in FIG. 3, the second example exhibits hardly any fall in proton conductivity. In comparison with this, however, the non-processed comparative example electrolyte membrane (intermediate product) shows a substantial fall in proton conductivity due to phosphorous elution. Given these results, it is clear that proton conductivity is made more stable as a result of phosphorous fixing caused by the microwave irradiation.

Evaluation of Heat Resisting Properties

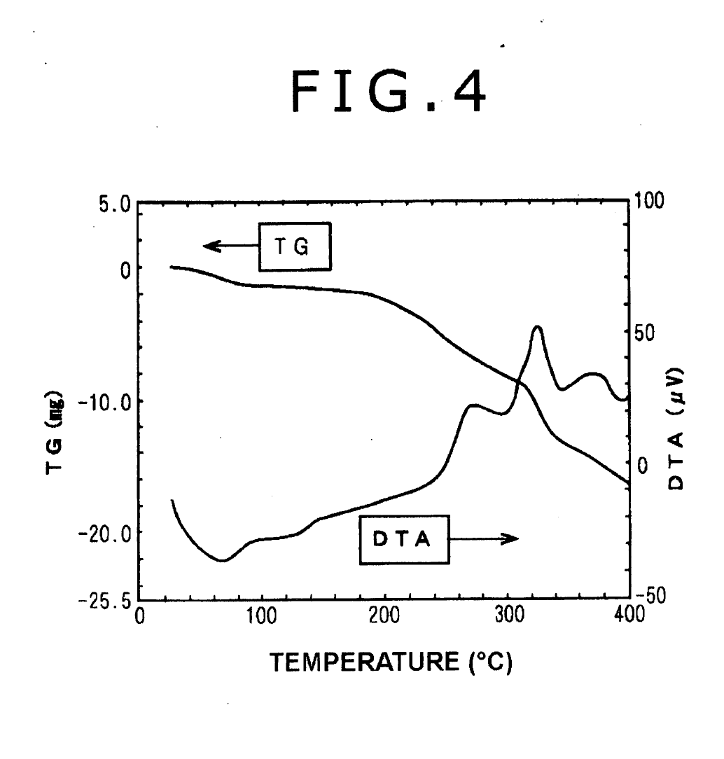

Using the first process step described above, an intermediate product was obtained with an average molecular weight of polyethylene glycol of 400 and a phosphorous to sulfur ratio of 2:1. Moreover, the thermal stability of the intermediate product was confirmed using TG-DTA The results are shown in FIG. 4.

As shown in FIG. 4, weight reduction resulting from release of absorbed water, and an endothermic reaction were observed up until about 200 degree C. However, from around 250 degrees C. and upwards, weight reduction resulting from destruction of the electrolyte membrane, and an exothermic reaction were observed. Based on these results, it is apparent that the intermediate product has adequate heat resisting properties up until around 200 degrees C. In other words, the heat resisting properties of the intermediate product are improved by the hybrid combination of the phosphoric acid and the polyethylene glycol of the skeleton. As a result, an electrolyte membrane is obtained that can operate in a higher temperature range than conventional electrolyte membranes.

### INDUSTRIAL APPLICABILITY

The combining method of the present invention can be desirably applied to manufacturing methods for fuel cell and sensors, and to the manufacture of electrodes for fuel cells, or similar. Further, it is preferable if the proton conducting material is phosphoric acid or a phoshide.

1. A combining method comprising a step of:
combining a proton conducting material including a hydroxyl group with a skeleton formed from a hydrocarbon-based polymer including a hydroxyl group, the combining step being executed by performing irradiation with microwaves with a wavelength that selectively imparts energy to the hydroxyl group.

2. The combining method according to claim 1, wherein
the hydrocarbon-based polymer includes metal alkoxide.

3. The combining method according to claim 1, wherein
the proton conducting material is one of phosphoric acid and a phoshide.
